(19) United States
(12) Patent Application Publication
(10) Pub. No.: US 2010/0311173 A1
(43) Pub. Date: Dec. 9, 2010

(54) Procedure and System for the Agricultural Evaluation of Livestock Excrement

(76) Inventor: Pere Baucells Guiteras, Vic (ES)

Correspondence Address: HONIGMAN MILLER SCHWARTZ & COHN LLP, 38500 WOODWARD AVENUE, SUITE 100, BLOOMFIELD HILLS, MI, 48304-5048, US

(21) Appl. No.: 11/660,578

(22) PCT Filed: Aug. 17, 2005
(86) PCT No.: PCT/ES05/00465

§ 371 Date: Aug. 9, 2007

(30) Foreign Application Priority Data
Aug. 17, 2004 (ES) P200402039

(51) Int. Cl. G01N 35/08

(52) U.S. Cl. 436/55

(57) ABSTRACT

A system consisting of livestock farms (2) that produce excrement; plots of arable land (3) for the agricultural utilisation of the excrement; and lorries (4) for transporting the excrement, which comprises the following steps:
a) providing at least one data server (7) in the form of a central processing and control unit that manages a database (5);
b) providing a user's client computer (12, 13) for the livestock farms (2) and the plots of arable land (3);
c) connecting the user's client computer to the data server through a data network (8);
d) providing the lorries (4) with a means of transmitting and receiving data (14) to the data server (7) through the data network;
e) determining the data for the parameters regarding the physical location of the livestock farms and the plots of arable land, and entering the data into said database (5) of said data server (7);
f) determining at all times the data about the production volume and the physicochemical characteristics of the excrement produced by each livestock farm, and entering the data into said database;
g) determining at all times the data about the excrement absorption capacity of each plot of arable land, and entering the data into said database;
h) determining at all times the data about the position and load status of all the lorries in the fleet, and entering the data into said database;
i) deciding, by means of a decision-making agent (6) that is connected to the data server, on the basis of the data about the volume and physicochemical data of the excrement produced by a livestock farm, the parameters of the absorption capacity of the plots and the parameters of availability, position and load status of the lorries in the fleet, at least one plot on which to spread the volume of excrement and at least one lorry in the fleet to transport it;
j) assigning, through said decision-making agent, the excrement associated with one or more lorries in the fleet;
k) said decision-making agent or said data server (7) sending a transport order to the assigned lorries;
l) transporting, by means of the assigned lorry or lorries, the associated excrement from each farm to the plot or plots decided in i); and
m) spreading the excrement on the assigned plot or plots.

### TECHNICAL FIELD

The present invention relates to a procedure for the agricultural evaluation of livestock excrement, in the form of slurry and manure, and to the system whereby said procedure is performed. In particular the evaluation system is of the type that consists of a plurality of livestock farms that produce excrement; a plurality of plots of arable land on which to spread the excrement for its use as organic fertilizer; and one or more vehicles for transporting the excrement or waste that is produced.

### BACKGROUND

The disposal of slurry produced by livestock farms is becoming a far-reaching and significant environmental problem. Effectively, livestock excrement, known as slurry, from poultry, cattle, sheep, and, mainly, pig farms, contains large proportions of nitrogen with a very high potential risk of contamination of aquifers and the atmosphere. In Europe, this is already quite noticeable in some regions of countries like the Netherlands and Spain, where pig farming is very widespread.

The disposal or utilization of this waste is currently carried out through a variety of alternative solutions, such as its utilization as an energy source or as an organic fertilizer, or agricultural utilization, with the possible mediation of intermediate processes of controlled biodegradation of the organic matter of the slurry under aerobic conditions, such as e.g. the process known as composting.

Some current models for agricultural evaluation of livestock excrement comprise the management of a system consisting of livestock farms that produce excrement, surfaces or plots of arable land on which to spread the excrement for its use as an organic fertiliser, one or more vehicles for transporting the excrement, in a certain geographical space and, occasionally, intermediate treatment plants, e.g. composting plants. The vehicles transport, in controlled hygiene conditions, the excrement produced by a livestock farm to a designated plot of arable land, on the basis of the physicochemical characteristics of the slurry or manure, the needs of the plot and the availability of vehicles. There might be intermediate transport from or to the intermediate treatment plants, e.g. composting plants.

This system poses significant management and logistics problems, as the system may have a surplus or shortfall of arable land in relation to the volume of livestock waste that the system produces.

In short, the current problem is to correct the imbalance that exists between the production of and demand for waste, particularly when it is not homogeneous, neither as regards to the volume produced per surface unit nor as regards to its constitution, and given the very dispersed nature of the production centers (farms) and the consumption centers (plots of arable land), in terms of both geography and the capacity of supply or demand.

Moreover, a large number of variables and parameters are involved in the production, storage and spreading or agricultural use of slurry, i.e. a large amount of information, which makes the management of this type of livestock excrement more complex.

The purpose of the present invention is to provide a procedure and system for managing the agricultural evaluation of livestock excrement in order to solve this problem.

### SUMMARY

A first aspect of the invention provides a procedure for the agricultural evaluation of livestock excrement, in the form of slurry and manure, in a system consisting of a plurality of livestock farms that produce the excrement; a plurality of plots of arable land on which to spread the excrement for its use as an organic fertiliser; and one or more vehicles for transporting the excrement, in accordance with claim 1.

Claims 2 to 25 describe preferred embodiments of the procedure of the invention.

A second aspect of the invention discloses a system for the agricultural evaluation of livestock excrement, for putting into practice the above-described procedure, the system consisting of a plurality of livestock farms that produce the excrement; a plurality of plots of arable land on which to spread the excrement for its use as an organic fertiliser; and one or more vehicles for transporting the excrement, in accordance with claim 26.

Claims 27 to 37 describe preferred embodiments of the system of the invention.

Another aspect of the present invention discloses instructions executable by computer, as described in claim 38.

Another aspect of the invention discloses a carrier medium for said instructions executable by computer.

The carrier medium can take the form of a storage medium and a carrier wave.

Another aspect of the invention discloses a computer program comprising instructions executable by computer, which causes a system for the agricultural evaluation of livestock excrement to perform the aforementioned procedure.

Persons skilled in the art will appreciate that the system and procedure disclosed in the present invention make it possible to collect, store and manage all the intricate and complex information involved in the production, storage and spreading or agricultural use of slurry.

All this is intended to improve the management of slurry, with the consequent environmental improvements that this implies.

### BRIEF DESCRIPTION OF DRAWINGS

Non-exclusive examples of preferred embodiments of the present invention are described below, accompanied by a set of drawings to aid a better understanding thereof, which are provided merely as a non-limiting example, wherein:

FIG. 1 is a general diagram of the system of the present invention;

FIGS. 2 to 4 correspond to schematic images of exemplary user interfaces for the example of the system shown in FIG. 1; and

FIG. 5 is a schematic image showing a exemplary user interface for the measurement in real time of the levels of excrement in the tanks.

### DETAILED DESCRIPTION

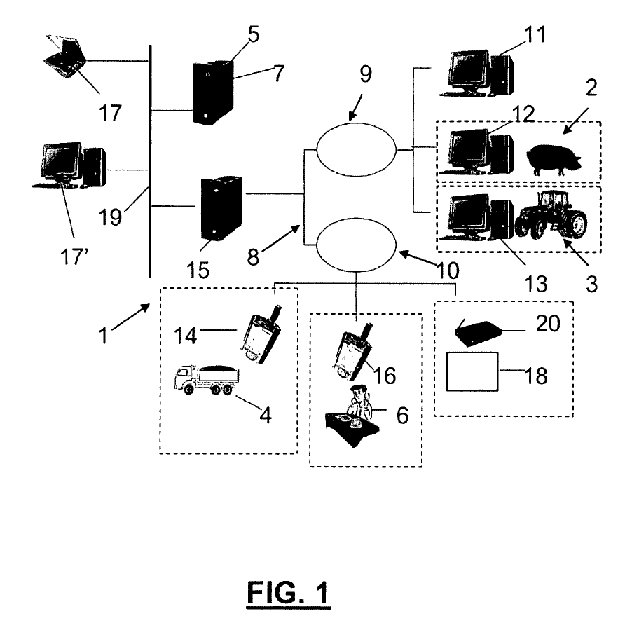

As can be seen in FIG. 1, the system 1 for the agricultural evaluation of livestock excrement, which allows an automatic, economical and environmentally-efficient management thereof, comprises, in a specific geographic environment, a plurality of livestock farms 2 that produce excrement (slurry and manure), and a plurality of surfaces or plots of arable land 3, or farms, on which to spread the excrement for its use as an organic fertilizer. The fertilizer may be spread after undergoing a physicochemical treatment step, such as e.g. composting.

It should be mentioned that each of the plots could be subdivided into other smaller surfaces, or “sub-plots”, although in conceptual terms there is no difference between these and the plots for the purposes of the present invention.

In FIG. 1 the livestock farms 2 are shown by the farm animal icon; the plots of arable land 3 are shown by the tractor icon, and the one or more vehicles 4 are shown by the vehicle icon.

The livestock farms 2 have tanks 18 for collecting slurry. One or more fleets of vehicles 4 are involved in the system, for transporting the excrement from the livestock farms 2 to the arable farms 3.

There is a data server 7, in the form of a central processing and control unit, for the processing of a database 5 used for managing the system 1. The data includes, among other variables, the physical location of the livestock farms 2 and the plots of arable land 3, the physical, chemical and production characteristics of the excrement produced by each livestock farm 2, the excrement absorption demand of each plot of arable land 3; the position, availability and load status of the one or more vehicles 4, data on the level of the slurry tanks 18 at the farms 2, and the like.

The one or more vehicles 4 may have systems that make it possible to determine their position in real time, for which they can have navigation systems, for example global positioning systems or the like.

A novel feature of the system 1 according to the invention is that it includes a decision-making agent 6, or “management coordinator”, which can be human or automatic, and which is linked to the server 7 for access to the database 5. The function of the decision-making agent 6 is to make decisions about the system: to decide the excrement from the farms 2 to be transported or spread, the physicochemical treatment to be applied thereto, the plot or plots 3 of arable land to receive such waste, the one or more vehicles 4 to transport said decided excrement, and the like.

The foregoing assignations are carried out by “tallying” criteria regarding slurry production and the demand for fertilizer, the physical, chemical and production characteristics of the excrement, the position, availability and load status of the one or more vehicles and the level of slurry in the tanks 18 at the farms 2.

In FIG. 1, the livestock farms 2 are linked to respective computers 12 and the plots 3 are linked to respective computers 13, the computers 12, 13 are connected to the data server 7 for entering data and communicating such data bi-directionally to the server 7 through a data network 8, which is preferably the Internet 9. In this case, each element in the system can have an IP address assigned to it.

The decision-making agent 6, shown in FIG. 1 by the person icon, can either be human, as in the exemplar case described herein, or it can be a decision-making system implemented by software on a computer, for example, provided within the server 7.

In an embodiment shown herein, the decision-making agent 6 is connected to the server 7 by means of a telephone network 10, e.g. a RAS network.

It is possible for external users to connect to the system 1, e.g. the public authorities or the general public, by means of client computers 11, in order to have access to the status of the management system 1 for slurry treatment, to register with management administration plans or the like.

Internal users 17, 17′ can be connected to an internal network 19 (LAN or WAN, for example). Among other examples, such users may manage and consult the information on the system 1 and issue reports. The data server 7 of the system may “hang” from this internal network 19, as does possible additional equipment, e.g. a central control computer 15 for centralizing communications.

The one or more vehicles 4 have a means for transmitting and receiving data 14 to the data server 7 by means of the data network 8. In the example shown herein, the one or more vehicles 4 may be connected and the transmission and reception may be provided via hand-held computers of the “PocketPC” or PDA type 14 or similar thereto.

The tanks 18 are connected to the data server 7 by the data network 8, through the means for transmission 20 (FIG. 1) and the means for measuring the level of slurry in the tanks 18 in real time and automatically, which can be by level sensors of a conventional type. When the sensors detect that the level of the tank 18 of accumulated slurry reaches or exceeds a predetermined level, they send a “tank full” signal to the data server 7 through the telephone network 10 of the network 8.

The tanks may have a means for transmitting data about the level to the server 7, in terms of its current value and/or its velocity of variation. The tanks 18 may have a means for generating alert signals when predetermined conditions are detected regarding the level and the velocity of variation in the level of the tanks 18, and a means for transmitting said alert signals to the server 7.

Information is therefore continually available on the server about the state of the level of the tanks 18, which can be used in the decision-making process of the decision-making agent 6.

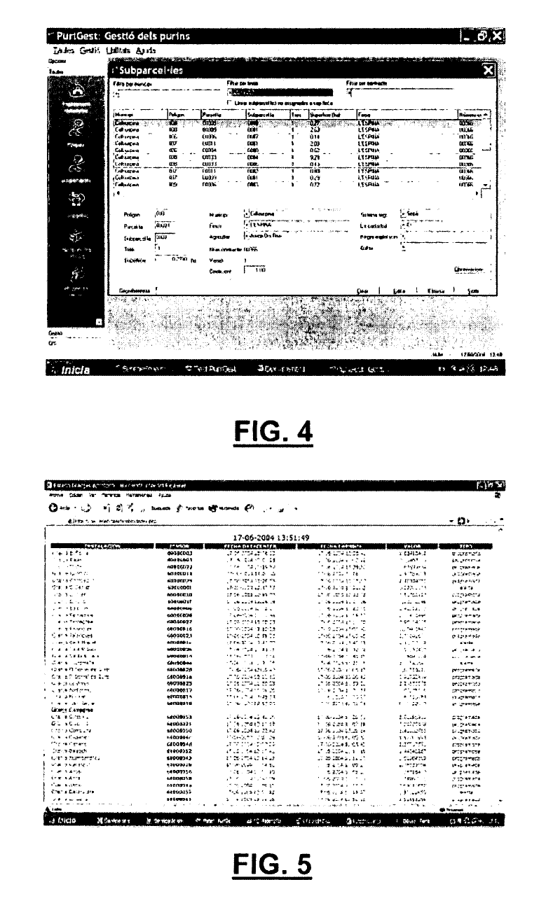

FIG. 5 shows a schematic drawing showing a possible user interface for the measurement and monitoring in real time of the levels of excrement in the tanks 18. In this FIG. 5, it is possible to see, for each farm (shown in the first column), the sensor for each of its tanks 18 (identified in the second column) and the height value for the level of the tank (shown in the fifth column).

The alert signals can be generated when the level exceeds the permitted predetermined level for a tank 18, when there is a sudden drop in the level, which could indicate a leakage, when there is an anomalous gradient in the rate at which the level falls, which would indicate incidents in the level of the tank and the like. On the basis of these alarm signals, the decision-making agent 6 can decide on the specific action to take.

The livestock farms 2 conveniently have at least one buffer tank, which is linked to the accumulation tank or tanks 18, into which the excrement is poured and from which it is transported to plants where it will undergo alternative or complementary processes for its agricultural utilization, such as treatment plants, biotransformation stations or cogeneration plants.

The basic operational procedure is as follows:

First, the data must be determined for the parameters regarding the physical location of the livestock farms 2 and the plots of arable land 3, e.g. by means of a system of UTM coordinates, and the data are entered into the database 5 of the data server 7.

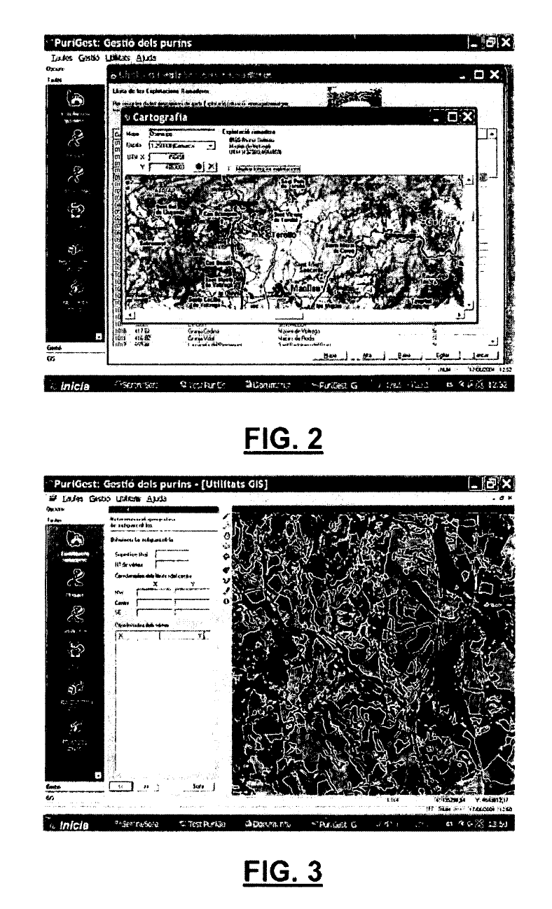

FIGS. 2 and 3 each show examples of possible graphical user interfaces for interaction between a user and the software application associated with the present invention. These figures show the main menu of the application in a column of icons on the left of the main screen.

On the screen shown in FIG. 2, the UTM coordinates have been entered for a particular livestock farm 2 on a cartographic map of the specific region.

On the screen shown in FIG. 3, it is possible to delimit, on a cartographic map of a different scale than that of the screen shown in FIG. 2, the perimeters of the plots 3 or sub-plots, parametrising the different data and entering or calculating the surface area.

FIG. 4 shows an example of a graphic interface that allows the different data corresponding to the plots 3 or sub-plots to be entered, which in this case are presented in municipal groupings.

In real time or when it is decided, the amount and nature of the supply of slurry is determined for each livestock farm 2 and the data about the production volume and the physical and chemical characteristics of the excrement production are sent to the database 5.

Likewise, for each plot of arable land 3 the data about its excrement absorption capacity is determined and sent by Internet 9 to the server 7.

The data regarding the position and load status of all the one or more vehicles 4 is established at all times by means of the GPS system. The data is sent by the “PocketPC” or the PDA 14 through the RAS network 10 to the server 7.

The decision-making agent 6, on inspecting the contents of the database 5, selects, on the basis of the data regarding the volume of excrement from the livestock farms 2, the parameters of absorption capacity of the plots 2 and the parameters of availability, position and load status of the one or more vehicles 4, at least one livestock farm 2, at least one plot 3 on which to spread the volume of excrement of the livestock farm, and at least one vehicle 4 to transport the excrement.

Specifically, the designated vehicle 4 or vehicles can be those that are closest to the livestock farm 2 in question.

Subsequently, the decision-making agent 6 or said data server 7 send the assigned one or more vehicles 4 a transport order, so that it may transport the associated excrement from each farm 2 to the decided plot or plots 3.

Then, the excrement is spread from the one or more vehicles onto the assigned plot or plots 3.

The decision to be made by the decision-making agent 6 can be a response to a request received from a livestock farm 2 (slurry supply), or a response to a request received from an arable farm 3 (slurry demand). The decision to be made can also be determined as a response to other requirements or specific events, such as a “tank full” alarm signal, a forecast of the production at a livestock farm 2, a forecast of the meteorological conditions in the area of the livestock farms 2 or the like.

For the latter case, each livestock farm 2, or a group of livestock farms in close proximity, preferably have meteorological stations that are adapted for recording the atmospheric conditions in the area of the farm 2 or farms, with a means of transmitting the recorded data to the server 7 in real time. The wind conditions, temperature, humidity, and intensity of any possible rain, snow or hail are transmitted to the server 7 and can be consulted by the decision-making agent 6 in order to make decisions.

The decision-making agent 6 therefore has the fundamental role of “tallying” the supply with the demand, from the qualitative and quantitative point of view of the slurry and the arable land.

Depending on the characteristics of the excrement produced, it is possible to determine and carry out a physicochemical and/or biological treatment of the excrement produced, in particular a composting process for the reduction of N, which is applicable to a certain volume of excrement. The decision-making agent 6 will then also consider the characteristics of the waste after this treatment has been carried out.

Characterizing the excrement absorption capacity of each plot of arable land 3 at all times can involve determining the nitrogen absorption capacity of the soil.

Characterizing the excrement in its original state involves measuring the N and P content of the excrement. This detection can be carried out by conventional means, e.g. by near-infrared (NIR) spectroscopy.

The NIR detector can be installed in the one or more vehicles 4, and the excrement is characterised during the transport step (1). For example, a situation might occur in which a specific tank 18 at a livestock farm 2 requires a vehicle 4 to collect the slurry. Once it has loaded the waste, and once on the road, it is possible to conduct the qualitative analysis of the slurry, the server 7 and the decision-making agent 6 being informed of these measured characteristics of the slurry in order to make an “on-the-spot” decision as to the plot of arable land 3 where the slurry is to be transported and spread, or the alternative treatment to which the slurry being transported must be subjected.

This system and procedure makes it possible to group the farms 2, plots of arable land 3 and composting plants into clusters, which are no more than a set of entities, in this case farms 2, plots of arable land 3 and composting plants, situated in a certain geographical area. By defining a maximum radius of the cluster, it is possible to calculate the maximum distance to which livestock waste or excrement is to be transported, which in turn makes it possible to calculate the transport costs, whether for spreading it on arable land or using it in a composting plant. The maximum radius will include a sub-set of lands and a given number of composting plants with a specific capacity. The cluster may have a surplus or shortfall of land in relation to the volume of livestock waste that is produced in the cluster.

The system and procedure of the invention make it possible to provide arable land with the correct and necessary quantities of nutrients for cultivation, avoiding the accumulation thereof in the soil and the lixiviation of harmful matter to subterranean waters with the consequent contamination of aquifers, through a procedure that allows the comprehensive online management of all the livestock farms 2 and arable farms 3. They make it possible to optimize resources, save energy and improve the environment, through the utilization and integration of new technologies.

The system 1 of the present invention collects, stores, lists and manages the information generated or required for each of the areas involved in the management of slurry. For the system to have all the necessary information, it has different means for recording and displaying the information, served by the server 7, with the integration of new technologies.

1-42. (canceled)

43. A process for evaluating livestock excrement in a system having one or more livestock farms that produce the excrement; one or more plots of arable land on which to spread the excrement for its use as an organic fertilizer; and one or more vehicles for transporting the excrement, said process comprising:
a) providing at least one server having a central processor and control unit that manages a database;
b) providing a client computer for at least one of the one or more livestock farms and at least one of the one or more plots of arable land;
c) connecting said client computers to the data server through a data network;
d) connecting the one or more vehicles to the data server through the data network;
e) determining the physical location of the one or more livestock farms and the or more plots of arable land, and entering the data into the database of the data server;
f) determining at all times the production volume and the physicochemical characteristics of the excrement produced by the one or more livestock farms, and entering the data into said database;
g) determining at all times the excrement absorption capacity of the one or more plots of arable land, and entering the data into said database;
h) determining at all times the position and load status of the one or more vehicles, and entering the data into said database;
i) deciding, by means of a decision-making agent that is connected to the server, on the basis of the production volume and the physicochemical property of the excrement produced by the one or more livestock farms, the absorption capacity of the one or more plots of arable land and the availability, position and load status of the one or more vehicles, at least one plot of the one or more plots of arable land on which to spread the volume of excrement produced by at least one of the one or more livestock farms and at least one of the one or more vehicles to transport the volume of excrement if the at least one of the one or more livestock farms;
j) assigning the at least one vehicle, through said decision-making agent, the volume of excrement produced by at least one of the one or more livestock farms;
k) at least one of said decision-making agent and said server sending a transport order to the at least one vehicle;
l) transporting, by means of the at least one vehicle, the volume excrement from said at least one of the one or more livestock farms to said one or more plots of arable land on which to spread the excrement; and
m) spreading the excrement on said one or more plots of arable land.

44. The process according to claim 43, wherein the deciding step further comprises the following substeps:
on the basis of the characteristics of the excrement produced, determining and carrying out one or both of a physicochemical and biological treatment of the excrement.

45. The process according to claim 44, wherein said one or both of said physicochemical and biological treatment of the excrement produced is a biological treatment that reduces the nitrogen content.

46. The process according to claim 45, wherein said one or both of said physicochemical and biological treatment of the excrement produce includes the composting of the excrement.

47. The process according to claim 43, wherein the deciding step is performed in response to a request received from one of said one or more livestock farms.

48. The process according to claim 43, wherein the deciding step is performed in response to a request received from one of said one or more plots of arable land.

49. The process according to claim 43, wherein said step of determining at all times the excrement absorption capacity of each of the one or more plots of arable land involves determining the nitrogen absorption capacity thereof.

50. The process according to claim 43, wherein said at least one vehicle of said one or more vehicles is closest to the one of the one or more livestock farms.

51. The process according to claim 43, wherein the physical location of the one or more livestock farms and the one or more plots of arable land are provided in UTM coordinates.

52. The process according to claim 43, wherein the position of the one or more vehicles is determined continuously in real time using a global position system or similar location system.

53. The process according to claim 43, wherein the step of determining the data about the excrement production of each of said one or more livestock farms involves measuring the volume of the excrement produce and conducting a physicochemical analysis of the excrement produced.

54. The process according to claim 53, wherein said physicochemical analysis involves measuring the nitrogen and phosphorous content of the excrement with a portable detector using near-infrared spectroscopy.

55. The process according to claim 54, wherein at least one of said one or more vehicles includes said portable detector and the step for performing said physicochemical analysis occurs during said step for transporting the excrement.

56. The process according to claim 55, wherein said step for deciding is carried out during said step for transporting the excrement.

57. The process according to claim 43, wherein said data network comprises the Internet.

58. The process according to claim 43, wherein each one of said one or more livestock farms, each one of said one or more plots of arable land and each one of said one or more vehicles is assigned an IP address.

59. The process according to claim 43, wherein said data network comprises a local network.

60. The process according to claim 43, wherein data transmission between the one or more vehicles and the decision-making agent is carried by means of a wireless telephone network.

61. The process according to claim 43, wherein at least some of the data is manually entered.

62. The process according to claim 43, wherein at least some the data is entered into a portable terminal that is connected to the data network through a RAS telephone system.

63. The process according to claim 43, further comprising:
providing, in at least one of the one or more livestock farms, at least one accumulation tank for the accumulation of excrement, into which the excrement produced is poured;
connecting the at least one accumulation tank to the data server through the data network;
measuring the level and the velocity of variation in the level of excrement in the at least one accumulation tank; and
transmitting the level and the velocity of variation in the level of excrement to the server.

64. The process according to claim 63, wherein the level and the velocity of variation in the level of the tanks is continuously transmitted to the data server.

65. The process according to claim 63, further comprising:
generating an alert signal when predetermined conditions are detected regarding the level and the velocity of variation in the level of the tanks; and
transmitting said alert signal to the server.

66. The process according to claim 63, further comprising:
providing, in at least one of the one or more livestock farms, at least one buffer tank linked to the at least one accumulation tank.

67. A system for managing the agricultural evaluation of livestock excrement that is generated from one or more livestock farms, and for managing the transport of the excrement to one or more plots of arable land on which to spread the excrement for its use as an organic fertiliser via one or more vehicles, said system comprising:
a database in communication with a data server having a central processing and control unit, said database adapted to store data about the physical location of the one or more livestock farms and the one or more plots of arable land; the physical, chemical and production characteristics of the excrement produced by the one or more livestock farms; the excrement absorption demand of the one or more plots of arable land; and the position, availability and load status of the one or more vehicles;
means of determining the position of the one or more vehicles; and
a decision-making agent means linked to the database for assigning the excrement generated from the one or more livestock farms to the one or more plots of arable land via the one or more vehicles, wherein the decision-making agent assigns the excrement to the one or more plots of arable land on the basis of the physical, chemical and production characteristics of the excrement, the excrement absorption demand, and wherein the decision-making agent assigns the excrement to the one or more vehicles one the basis of the position, availability and load status of the one or more vehicles.

68. The system according to claim 67, wherein each of said one or more livestock farms and each of said one or more plots of land have client computers in communication with the data server for data manipulation.

69. The system according to claim 67, wherein each of said one or more vehicles are connected to at least one of the data server and the decision-making agent.

70. The system according to claim 67, wherein said one or more livestock farms comprise:
one or more excrement accumulation tanks, wherein said one or more excrement accumulation tanks; and
a sensor for measuring the level and the velocity of variation in the level of the excrement in the tanks, wherein the sensor is connected to the data server through the data network.

71. The system according to claim 70, wherein the sensor continuously transmits the level and the velocity of variation in the level of excrement in the tanks to the data server.

72. The system according to claim 71, further comprising:
an alarm that that generates a signal when one of or both of the level and the velocity of variation in the level of excrement reach a predetermined level.

73. The system according to claim 70, further comprising:
a buffer tank linked to the one or more accumulation tanks, into which the excrement is poured and from which it is transported to plants where it will undergo alternative or complementary processes for its agricultural utilisation, such as treatment plants, biotransformation stations or cogeneration plants.

74. The system according to claim 67, wherein the one or more vehicles include detectors having near-infrared spectroscopy adapted to characterize the excrement as it is being transported.

75. The system according to claim 67, wherein the one or more livestock farms comprise a meteorological station that is adapted to record and transmit the atmospheric conditions to the server in real time.

75. A method for evaluating livestock excrement in a system consisting of one or more livestock farms that produce excrement to thereby transport the excrement to one or more plots of arable land via one or more vehicles, said method comprising:
determining the physical location of the one or more livestock farms and the one or more plots of arable land, and entering the data into a database of a data server;
determining at all times a production volume and a physical and chemical characteristic of the excrement associated each of the one or more livestock farms, and entering these values into said database;
determining at all times an excrement absorption capacity of each plot of the one or more plots of arable land, and entering these values into said database;
determining at all times a position and a load status of each vehicle of the one or more vehicles and entering these values into said database;
deciding, by means of a decision-making agent in communication with the data server, on the basis of a volume of excrement from at least one of said one of the one or more livestock farms, the capacity of each one of the one or more plots of arable land and the availability, position and load status of each one of the one or more vehicles, at least one plot of arable land from said one or more plots of arable land on which to spread the volume of excrement and at least one vehicle from the one or more vehicles to transport the volume of excrement;
assigning, through said decision-making agent, the volume of excrement to said at least one vehicle from said one or more vehicles; and
said decision-making agent or said data server sending a transport order to said at least one vehicle from said one or more vehicle.
